(19) United States
(12) Patent Application Publication
(10) Pub. No.: US 2026/0276794 A1
(43) Pub. Date: Sep. 17, 2026

(54) LIGHT-EMITTING UNIT AND OPTICAL SENSOR

(71) Applicant: DENSO CORPORATION, Kariya-city (JP)

(72) Inventors: Yuhei SHIMIZU, Kariya-city (JP); Masato NAKAJIMA, Kariya-city (JP)

(21) Appl. No.: 19/678,390

(22) Filed: May 15, 2026

Related U.S. Application Data
(63) Continuation of application No. PCT/JP2024/033824, filed on Sep. 24, 2024.

(30) Foreign Application Priority Data
Nov. 17, 2023 (JP) 2023-196232

(51) Int. Cl. G01S 7/484

(52) U.S. Cl. CPC G01S 7/484

(57) ABSTRACT

A light emitting unit for an optical sensor is disclosed. The sensor detects a target by receiving reflected light in response to irradiation light directed toward a sensing area. The light emitting unit includes a resonant circuit with an inductor and a capacitor, a light emission branch path with a light emitting diode, and a discharge switch for controlling capacitor discharge. A control branch path and a second charge switch are provided for managing charging to the capacitor. A drive circuit independently controls the discharge switch, first charge switch, and second charge switch, and switches between two control modes. In the first mode, the on-period of the first charge switch is controlled during the on-period of the second charge switch. In the second mode, the on-period of the second charge switch is controlled during the off-period of the first charge switch.

### CROSS REFERENCE TO RELATED APPLICATION

The present application is a continuation application of International Patent Application No. PCT/JP2024/033824 filed on Sep. 24, 2024, which designated the U.S. and claims the benefit of priority from Japanese Patent Application No. 2023-196232 filed on Nov. 17, 2023. The entire disclosures of all of the above applications are incorporated herein by reference.

### TECHNICAL FIELD

The present disclosure relates to an optical sensor for sensing an object.

### BACKGROUND ART

An optical sensor that receives reflected light from irradiated light includes a light-emitting diode that emits light in response to discharge of a capacitor.

### SUMMARY

According to at least one embodiment, a light emitting unit is provided in an optical sensor. The optical sensor senses a target by receiving reflected light from the target in response to irradiation light emitted toward a sensing area. The light emitting unit emits the irradiation light. The light emitting unit has a resonant circuit that includes an inductor and a capacitor. A light emission branch path branches from a branching point between the inductor and the capacitor in the resonant circuit. A light emitting diode is provided in the light emission branch path and generates the irradiation light by light emission. A discharge switch is provided in the light emission branch path and switches discharge from the capacitor. A control branch path branches from the inductor side relative to the branching point of the light emission branch path in the resonant circuit. A first charge switch is provided in the control branch path and switches on and off charging to the capacitor. A second charge switch is provided in the resonant circuit on the inductor side relative to the branching point of the light emission branch path, and switches on and off charging to the capacitor. A drive circuit individually controls on and off operation of the discharge switch, the first charge switch, and the second charge switch. The drive circuit may switch between a first control mode and a second control mode. The first control mode is a mode in which, prior to an on-timing of the discharge switch, an on-period of the first charge switch is controlled during an on-period of the second charge switch. The second control mode is a mode in which, prior to an on-timing of the discharge switch, an on-period of the second charge switch is controlled during an off-period of the first charge switch.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a cross-sectional view illustrating a configuration of an optical sensor according to a first embodiment.

FIG. 2 is a schematic diagram illustrating a mechanical configuration of a light-emitting unit according to the first embodiment.

FIG. 3 is a schematic diagram illustrating a mechanical configuration of a light-receiving unit according to the first embodiment.

FIG. 4 is a circuit diagram illustrating an electrical configuration of the light-emitting unit according to the first embodiment.

FIG. 5 is a graph showing light emission characteristics of the light-emitting unit according to the first embodiment.

FIG. 6 is a graph showing the light emission characteristics of the light-emitting unit according to the first embodiment.

FIG. 7 is a graph showing the light emission characteristics of the light-emitting unit according to the first embodiment.

FIG. 8 is a circuit diagram illustrating a configuration of a light-emitting unit according to a second embodiment.

FIG. 9 is a graph showing light emission characteristics of the light-emitting unit in a first control mode according to the second embodiment.

FIG. 10 is a graph showing the light emission characteristics of the light-emitting unit in the first control mode according to the second embodiment.

FIG. 11 is a graph showing the light emission characteristics of the light-emitting unit in the first control mode according to the second embodiment.

FIG. 12 is a graph showing the light emission characteristics of the light-emitting unit in a second control mode according to the second embodiment.

FIG. 13 is a graph showing the light emission characteristics of the light-emitting unit in the second control mode according to the second embodiment.

FIG. 14 is a graph showing the light emission characteristics of the light-emitting unit in the second control mode according to the second embodiment.

FIG. 15 is a circuit diagram showing a configuration of a light-emitting unit according to a modification of the second embodiment.

FIG. 16 is a graph showing light emission characteristics of the light-emitting unit according to the modification of the second embodiment.

FIG. 17 is a graph showing the light emission characteristics of the light-emitting unit according to the modification of the second embodiment.

FIG. 18 is a graph showing the light emission characteristics of the light-emitting unit according to the modification of the second embodiment.

### DETAILED DESCRIPTION

To begin with, examples of relevant techniques will be described.

An optical sensor of a comparative example receives reflected light with respect to irradiated light. The optical sensor includes a resonant circuit having an inductor and a capacitor, and a light-emitting diode. The charging and discharging of this capacitor are switched by a switch (switching element), so that the light-emitting diode emits light in accordance with the discharge of the capacitor.

In the optical sensor of the comparative example, peak intensity of the irradiated light emitted remains unchanged. Therefore, for example, when reflected intensity of the irradiated light decreases, such as with distant targets, insufficient received intensity of the reflected light may occur, potentially leading to a reduction in sensing accuracy.

In contrast to the comparative example, according to a light-emitting unit and an optical sensor of the present disclosure, sensing accuracy of a target object can be ensured.

According to one aspect of the present disclosure, a light emitting unit is provided in an optical sensor. The optical sensor senses a target by receiving reflected light from the target in response to irradiation light emitted toward a sensing area. The light emitting unit emits the irradiation light. The light emitting unit has a resonant circuit that includes an inductor and a capacitor. A light emission branch path branches from a branching point between the inductor and the capacitor in the resonant circuit. A light emitting diode is provided in the light emission branch path and generates the irradiation light by light emission. A discharge switch is provided in the light emission branch path and switches discharge from the capacitor. A control branch path branches from the inductor side relative to the branching point of the light emission branch path in the resonant circuit. A first charge switch is provided in the control branch path and switches on and off charging to the capacitor. A second charge switch is provided in the resonant circuit on the inductor side relative to the branching point of the light emission branch path, and switches on and off charging to the capacitor. A drive circuit individually controls on and off operation of the discharge switch, the first charge switch, and the second charge switch. The drive circuit switches between a first control mode and a second control mode. The first control mode is a mode in which, prior to an on-timing of the discharge switch, an on-period of the first charge switch is controlled during an on-period of the second charge switch. The second control mode is a mode in which, prior to an on-timing of the discharge switch, an on-period of the second charge switch is controlled during an off-period of the first charge switch.

According to this configuration, a light-emitting diode that generates irradiated light by light emission and a discharge switch that switches the discharge from the capacitor on and off are provided in the light emission branch path, which branches the branch point between the inductor and the capacitor in the resonant circuit. Furthermore, in the control branch path, which branches from the inductor side with respect to the branching point of the light emission branch path in the resonant circuit, the charging switch that turns the charging of the capacitor ON and OFF is provided. As a result, even when the received light intensity of the reflected light with respect to the irradiated light is insufficient, it is possible to relatively enhance the light receiving sensitivity by extending and controlling the ON period of the charging switch prior to the ON timing td of the discharge switch. Consequently, by such extension control, the peak intensity of the irradiated light can be increased to a high level suitable for the reception of the reflected light, thereby ensuring the sensing accuracy of the target.

The following will describe embodiments of the present disclosure with reference to the drawings. In the respective embodiments, corresponding components are denoted by the same reference numerals, and redundant descriptions may be omitted. Further, in cases where only a part of a configuration is described in each embodiment, the other parts of the configuration may be applied using the configurations described in the preceding embodiments. Further, not only the combinations of the configurations explicitly shown in the description of the respective embodiments, but also the configurations of the plurality of embodiments can be partially combined together even if the configurations are not explicitly shown if there is no problem in the combination in particular.

### First Embodiment

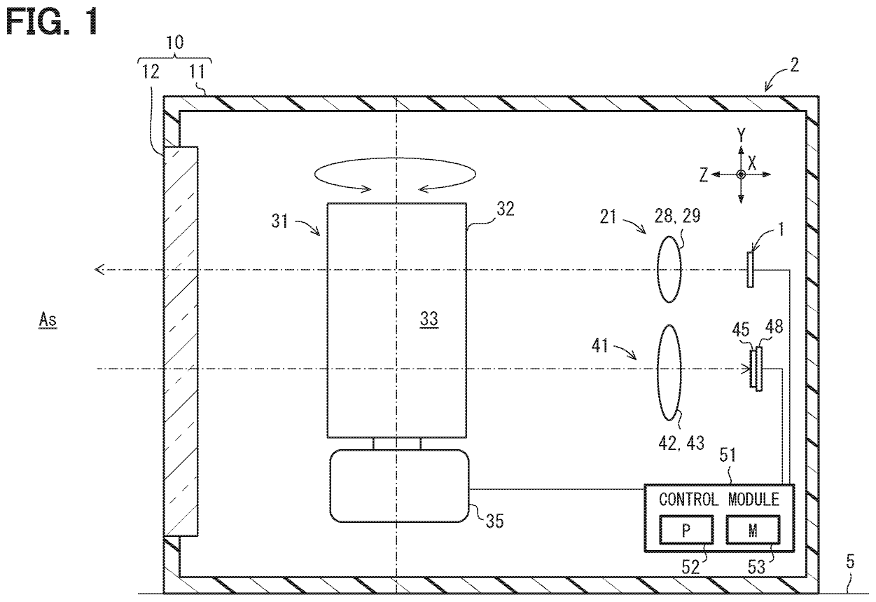

As shown in FIG. 1, a first embodiment of the present disclosure relates to an optical sensor 2 including a light-emitting unit 1. The optical sensor 2 is mounted on a vehicle 5. The vehicle 5 is a mobile body such as an automobile that can travel on a traveling path while an occupant is on the vehicle 5.

The vehicle 5 is capable of executing a constant or temporary automated traveling in an automated driving control mode. Here, the automated driving control mode may be achieved with an autonomous operation control, such as conditional driving automation, advanced driving automation, or full driving automation, where the system in operation performs all driving tasks. The automated driving control mode may be achieved with an advanced driving assistance control, such as driving assistance or partial driving automation, where the occupant performs some or all driving tasks. The automated driving control mode may be implemented by any one of autonomous driving control or advanced driving assistance control, by a combination thereof, or by switching between them.

In the following description, unless otherwise specified, each direction of the front, the rear, the top, the bottom, the left, and the right is defined with respect to the vehicle 5 on a horizontal plane. Further, a horizontal direction refers to a parallel direction with respect to a horizontal plane that serves as a direction reference for the vehicle 5. Furthermore, a vertical direction refers to a direction perpendicular to a horizontal plane serving as a direction reference for the vehicle 5.

The optical sensor 2 is a so-called LiDAR (Light Detection and Ranging/Laser Imaging Detection and Ranging) for acquiring image data that can be used for driving control of the vehicle 5 including the automated control driving mode. The optical sensor 2 is disposed in at least one of a front portion, left and right side portions, a rear portion, and an upper roof of the vehicle 5.

In the optical sensor 2, a three-dimensional orthogonal coordinate system is defined by three mutually orthogonal axes: an X-axis, a Y-axis, and a Z-axis. Particularly in the present embodiment, the X-axis and the Z-axis are set along different horizontal directions of the vehicle 5, and the Y-axis is set along the vertical direction of the vehicle 5. In FIG. 1, the left side of the dashed dotted line along the Y axis (the side of a light-transmitting panel 12 described later) actually shows a cross section perpendicular to the right side of the dashed dotted line (the side of the modules 21 and 41 described later) given by the three-dimensional orthogonal coordinate system.

The optical sensor 2 emits light toward a sensing area A0 in the external space of the vehicle 5, the sensing area A0 being determined by the placement location and field of view angle of the sensor. The optical sensor 2 receives reflected light that is incident when the irradiated light is reflected from the sensing area A0. In response to the reception of the reflected light with respect to the irradiated light, the optical sensor 2 senses a target that reflects the light in the sensing area A0. In particular, the sensing means that, among a reflection point distance from the optical sensor 2 to the target and a reflection intensity from the target, at least the former is measured.

A typical sensing target object in the optical sensor 2 applied to the vehicle 5 may be at least one of moving objects such as a pedestrian, a cyclist, an animal other than a human, and other vehicles. The typical sensing target object in the optical sensor 2 applied to the vehicle 5 may be at least one type of stationary objects such as a guardrail, a road sign, a structure beside a road, and a fallen object on a road.

The optical sensor 2 includes a casing module 10, a light projecting module 21, a scanning module 31, a light receiving module 41, and a control module 51. The casing module 10 includes a housing 11 and a light-transmitting panel 12. The housing 11 is formed in a hollow box shape and is mainly made of a light-shielding member such as metal or synthetic resin. The housing 11 accommodates the light projecting module 21, the scanning module 31, and the light receiving module 41 therein. The housing 11 holds a light-transmitting panel 12 formed into a plate shape from a light-transmitting material such as glass or synthetic resin.

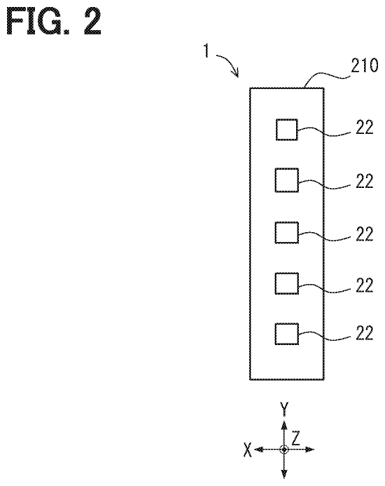

The light projecting module 21 includes the light emitting unit 1 and a light projecting lens system 28. As shown in FIG. 2, the light emitting unit 1 is constructed by mounting a plurality of light emitting diodes 22 in an array on a substrate 210. Each light-emitting diode 22 generates pulsed infrared laser light to be irradiated onto the sensing area A0 under the control of the control module 51. Each such light emitting diode 22 is provided as a laser diode, such as an edge emitter laser or a vertical cavity surface emitting laser (VCSEL).

As shown in FIG. 1, the light projecting lens system 28 projects the irradiated light emitted by the light emitting unit 1 onto the scanning mirror 32 of the scanning module 31. The light projecting lens system 28 provides at least one type of optical function among, for example, condensing, collimating, and shaping. The light projecting lens system 28 forms a projection optical axis along the Z axis. The light projecting lens system 28 has at least one projecting lens 29 on the projection optical axis, the lens shape of which corresponds to the optical effect to be exhibited. The light emitting unit 1 is positioned on the projection optical axis of the light projecting lens system 28. In the light-emitting unit 1, the irradiated light emitted by each light-emitting diode 22 is guided along the light-projecting optical axis of the light projecting lens system 28.

The scanning module 31 includes a scanning mirror 32 and a scanning motor 35. The scanning mirror 32 is formed into a plate shape by depositing a reflective film on a reflective surface 33, which is one side of a base material. The scanning mirror 32 is supported by the housing 11 so as to be rotatable around (in other words, in a periphery of) a rotation center line along the Y-axis. The scanning mirror 32 oscillates within a driving range that is limited by the function of a mechanical or electrical stopper.

The scanning mirror 32 is provided in common to the light projecting module 21 and the light receiving module 41. The scanning mirror 32 illuminates the sensing area A0 (sensing area “As” in FIG. 1) through the light-transmitting panel 12 by reflecting the irradiated light incident from the projection lens system 28 of the light projection module 21 on the reflection surface 33, which is oriented according to the rotation angle, thereby scanning the area A0 both temporally and spatially. In particular, in the optical sensor 2, the mechanical scanning of the sensing area A0 by the irradiated light is substantially limited to scanning in the horizontal direction.

Simultaneously with this scanning, the scanning mirror 32 further reflects the reflected light incident from the sensing area A0 through the light-transmitting panel 12 toward the light-receiving module 41 by the reflecting surface 33 oriented according to the rotation angle. Here, the speed of the irradiation light and the reflection light are sufficiently large relative to the rotational speed of the scanning mirror 32. As a result, the reflected light of the irradiated light is guided toward the light receiving module 41 side so as to travel in the opposite direction to the irradiated light by the scanning mirror 32 which has approximately the same rotation angle as the irradiated light.

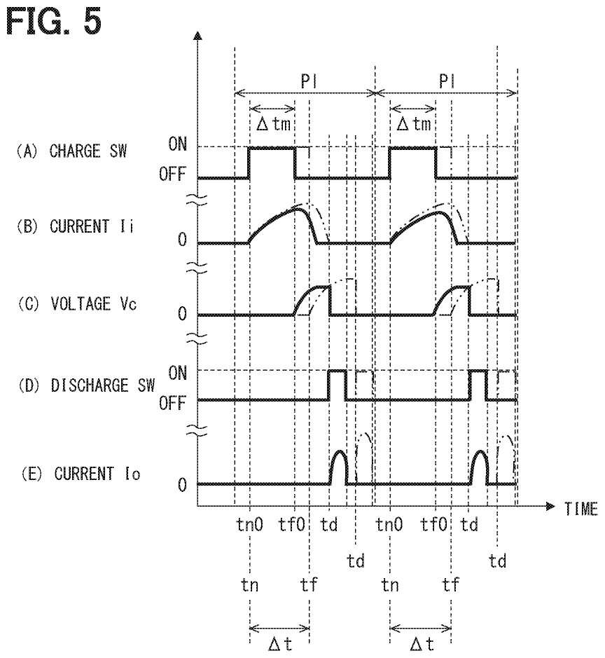

The scanning motor 35 is, for example, a voice coil motor, a direct current motor with brushes, a stepping motor, or the like. The scanning motor 35 drives the scanning mirror 32 to rotate (i.e., swing) within the finite driving range under the control of the control module 51. At this time, the rotation angle of the scanning mirror 32 is changed sequentially in synchronization with the light emitting cycle P1 (see FIG. 5 described later) of the light-emitting unit 1 of the light-projecting module 21.

The light receiving module 41 is arranged offset in the Y-axis direction relative to the light projecting module 21. The light receiving module 41 includes a light receiving lens system 42 and a light receiving unit 45. The light receiving lens system 42 exerts an optical effect so as to form an image of the light reflected from the sensing area A0 on the light receiving unit 45. The light receiving lens system 42 forms a light receiving optical axis along the Z axis. The light receiving lens system 42 has at least one light receiving lens 43 on the light receiving optical axis, which has a lens shape depending on the optical effect to be exerted. The reflected light incident on the reflecting surface 33 of the scanning mirror 32 is guided along the light receiving optical axis of the light receiving lens system 42 regardless of the rotation angle of the scanning mirror 32 within the driving range.

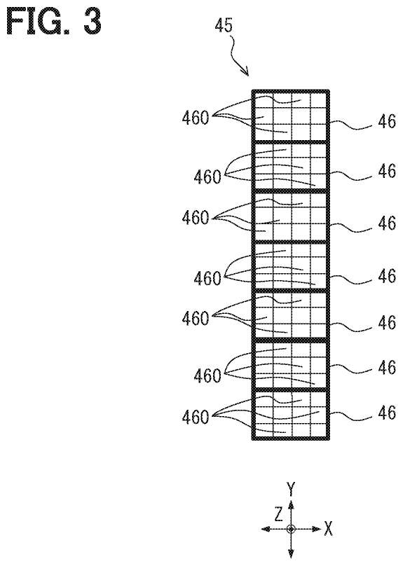

The light receiving unit 45 is positioned on the light receiving optical axis of the light receiving lens system 42. As shown in FIG. 3, the light receiving unit 45 is constructed by arranging a plurality of light receiving pixels 46 in an array on the substrate. Each of the light-receiving pixels 46 is further constructed from a plurality of light-receiving elements 460. The light receiving elements 460 of each light receiving pixel 46 are formed mainly of a photodiode such as a single photon avalanche diode (SPAD), for example. With this configuration, each light-receiving pixel 46 receives reflected light incident from the light-receiving lens system 42 at each light-receiving element 460.

As shown in FIG. 1, the light receiving unit 45 has an output circuit 48 integrated therein. The output circuit 48 executes sampling processing under control of the control module 51 for each scanning line associated with the rotation angle of the scanning mirror 32 according to the light emitting period Pl. Therefore, the output circuit 48 generates light receiving data for each scanning line based on the output signals from the light receiving pixels 46 of the light receiving unit 45 through sampling processing. The light receiving data thus generated is output from the output circuit 48 to the control module 51.

The control module 51 is mainly composed of at least one computer having a processor 52 and a memory 53. The control module 51 may be entirely housed inside the housing 11 (example of FIG. 1). The control module 51 may be located entirely in the vehicle 5 outside the housing 11. The control module 51 may be distributed across the interior of the housing 11 and the exterior of the vehicle 5.

The control module 51 is connected to the light-emitting unit 1, the scanning motor 35, and the output circuit 48. The control module 51 controls these connected objects by executing a control program stored in the memory 53 using the processor 52. Specifically, the control module 51 controls the light emission of each light-emitting diode 22 in the light-emitting unit 1 and the rotation of the scanning mirror 32 by the scanning motor 35 in synchronization with each light emitting period P1. In parallel with this control, the control module 51 acquires light receiving data from the output circuit 48 for each scanning line, which corresponds to each light emitting period Pl, thereby sensing at least the reflection point distance from the optical sensor 2 to the target and generating sensing information based on the light receiving data.

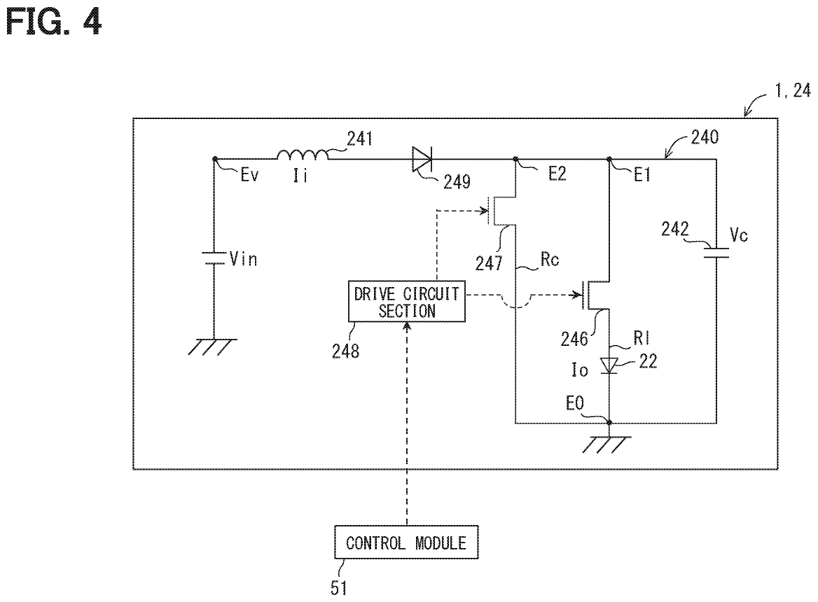

Next, the detailed configuration of the light-emitting unit 1 shown in FIG. 4 will be described. In the light-emitting unit 1, a plurality of light-emitting circuits 24 corresponding to the number of the light-emitting diodes 22 are constructed. In addition to the light emitting diode 22, the light emitting circuit 24 includes a resonant circuit 240, switches 246 and 247, and a drive circuit 248. FIG. 4 shows a representative light emitting circuit 24 corresponding to one light emitting diode 22.

The resonant circuit 240 is provided with a power supply terminal Ev to which a power supply voltage Vin is applied, and a ground terminal E0 to which a ground voltage is applied. The resonant circuit 240 is a so-called LC series circuit having an inductor 241 and a capacitor 242 connected in series between the power supply terminal Ev and the earth terminal E0. The inductor 241 is mainly composed of an induction coil. The capacitor 242 is mainly composed of a heat-resistant capacitor such as an electrolytic type.

In the light emitting circuit 24, a section from an intermediate point E1 between the inductor 241 and the capacitor 242 in the resonant circuit 240 to a ground terminal E0 is connected in parallel with the capacitor 242 by a light emitting branch path R1. The light emitting branch path Rl is provided with a discharge switch (discharge switching element) 246. The discharge switch 246 is mainly composed of a field effect transistor such as a MOSFET (Metal Oxide Semiconductor Field Effect Transistor). By virtue of this arrangement and configuration in the light-emitting branch path Rl, the discharge switch 246 can turn on and off the discharge from the capacitor 242 by switching.

In the light-emitting circuit 24, the light-emitting diode 22 is provided on the light-emitting branch path R1 from the intermediate point E1 to the ground terminal E0 closer to the ground terminal E0 than the discharge switch 246. A forward direction in which the light emitting diode 22 rectifies the current Io is set to a direction from the discharge switch 246 side toward the ground terminal E0 side. The light emitting diode 22 emits light by discharging the capacitor 242 in response to the discharge switch 246 being turned on, thereby generating irradiated light.

In the light emission circuit 24, an intermediate point E1 is provided between the inductor 241 and the capacitor 242 in the resonant circuit 240. Another intermediate point E2 is provided on the inductor 241 side relative to the intermediate point E1. A section from the intermediate point E2 to the ground terminal E0 is connected by a control branch path Rc. The control branch path Rc is connected in parallel with the capacitor 242 and the light emission branch path Rl. A charging switch 247 is provided in the control branch path Rc. The charge switch 247 is mainly composed of a field effect transistor such as a MOSFET. By arranging the charging switch 247 in the control branch path Rc, the charging switch 247 can switch on and off the charging to the capacitor 242. Furthermore, a diode 249 for preventing reverse current is provided between the inductor 241 and the intermediate point E2 in the resonant circuit 240. This diode 249 reduces a decrease in the charging voltage Vc to the capacitor 242.

In the light emitting circuit 24, a drive circuit 248 is connected to each of the switches 246 and 247. The drive circuit 248 is also connected to the control module 51. The drive circuit 248 drives the switches 246 and 247 to turn on and off individually as shown in FIGS. 5 to 7. That is, the switching of each of the switches 246 and 247 is controlled by the on/off driving function of the driving circuit 248.

As shown by the solid and dashed line graphs in each of the sub-figures (A) of FIGS. 5 to 7, in the drive circuit 248, a reference ON-timing Tn0 for switching the charge switch 247 from an off drive state to an on drive state is set to match the initial timing of each light emitting period Pl. At the same time, in the drive circuit 248, a reference OFF-timing Tf0 for switching the charge switch 247 from the on drive state to the off drive state is set to a timing a certain period ΔTm after the reference ON-timing Tn0 for each light emitting period Pl. With such a period setting for the reference ON-timing tn0 and the reference OFF-timing tf0, a minimum ON period Δtm is defined for the charging switch 247.

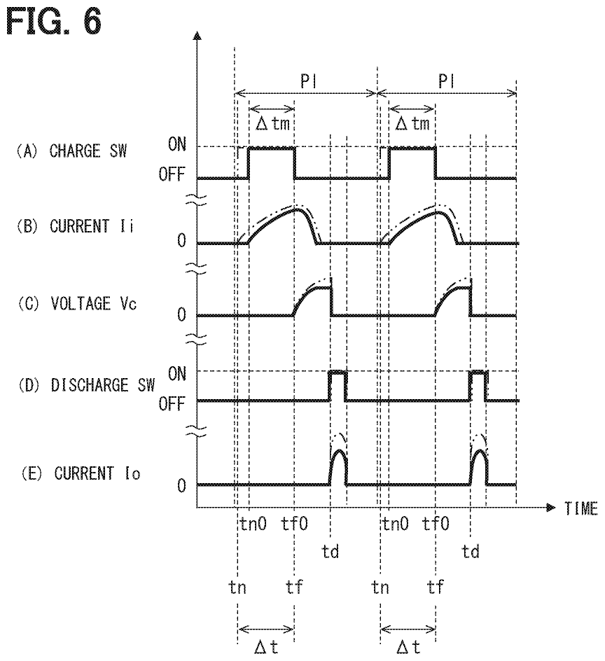

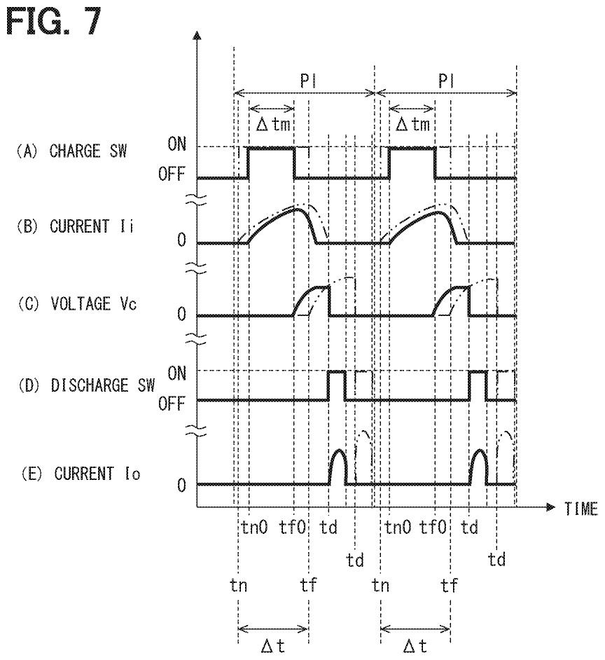

In the drive circuit 248, the ON period Δt of the charging switch 247 is controlled to a duration equal to or longer than the minimum ON period Δtm for each light emission cycle Pl. At this time, for the charge switch 247, as shown by the two-dot chain line graph in FIG. 5(A), while the ON-timing tn is adjusted to match the reference ON-timing tn0, the OFF-timing tf may be adjusted to a variable timing after the reference OFF-timing tf0. For the charging switch 247, as shown by a two-dot chain line graph in FIG. 6(A), the OFF-timing tf is adjusted in accordance with the reference OFF-timing tf0, while the ON-timing tn may be adjusted to a variable timing earlier than the reference ON-timing tn0, as long as it is after the initial timing of each light emission cycle Pl. For the charging switch 247, as shown by a two-dot chain line graph in FIG. 7(A), the ON-timing tn may be adjusted to a variable timing earlier than the reference ON-timing tn0, as long as it is after the initial timing of each light emission cycle Pl, and the OFF-timing tf may also be adjusted to a variable timing later than the reference OFF-timing tf0.

When the drive circuit 248 controls the ON period Δt of the charging switch 247 to be extended from the minimum ON period Δtm, the time and magnitude of the current Ii (see FIG. 4) flowing through the inductor 241 in the resonance circuit 240 increase. This phenomenon can be confirmed by the solid line graph and the two-dot chain line graph shown in sub-figure (B) of FIGS. 5 to 7. Furthermore, in the resonance circuit 240, the voltage Vc (see FIG. 4) charged to the capacitor 242 also increases. This increase is shown by the solid line graph and the two-dot chain line graph in sub-figure (C) of FIGS. 5 to 7. That is, the more the drive circuit 248 extends the ON period Δt of the charging switch 247 from the minimum ON period Δtm, the higher the charging voltage Vc of the capacitor 242 becomes. On the other hand, when the charging switch 247 remains in the OFF state, the charging voltage Vc of the capacitor 242 is, at most, a value according to Equation 1 using the power supply voltage Vin. In contrast, when the charging switch 247 is turned ON and the ON period Δt is extended, the charging voltage Vc of the capacitor 242 increases within the range defined by Equation 2 using the power supply voltage Vin.

$$Ve = 2 * Vin \qquad ( 1 )$$

$$Ve > 2 * Vin \qquad ( 2 )$$

Therefore, as shown by the solid line graphs in each of the sub-figures (D) of FIGS. 5 to 7, in the drive circuit 248, the discharge switch 246, which is in the off-drive state, is driven on at a timing later than the OFF-timing Tf of the charge switch 247 for each light-emitting period Pl. In other words, the control of the ON period Δt during which the charge switch 247 is driven ON precedes the ON-timing td at which the discharge switch 246 is switched from an off state to an on state for each light emission period Pl.

In response to the ON driving of the discharge switch 246, in the light emitting branch path Rl, the discharge current discharged from the capacitor 242, which is in the charged voltage Vc state, flows in through the resonant circuit 240. As a result, a current Io (see also FIG. 4) that rises and falls in accordance with the charging voltage Vc flows through the light-emitting diode 22, and the light-emitting diode 22 emits light with a peak intensity that follows the rise and fall of the current Io, as shown by the solid line graphs and dashed-dot line graphs corresponding to the each of sub-figures (E) of FIGS. 5 to 7.

The control module 51 recognizes, based on the received light data obtained from the output circuit 48, a state in which the received light intensity of the reflected light from a distant target falls below the lower limit intensity required to ensure sensing accuracy in the light receiving unit 45. When this state is recognized, the control module 51 issues an extension control command for the ON period Δt to the drive circuit 248. The drive circuit 248 controls the ON/OFF operation of the charging switch 247 so as to extend the ON period Δt within the range after the initial timing of each emission cycle Pl, in accordance with the degree of shortfall from the lower limit of the received light intensity.

### Actions and Effects

The actions and the effects of the first embodiment described above are described below. According to the first embodiment, the light emission branch path Rl, which branches between the inductor 241 and the capacitor 242 in the resonant circuit 240, is provided with a light emitting diode 22 that generates irradiated light and a discharge switch 246 that turns the discharge from the capacitor 242 ON and OFF. Furthermore, in the control branch path Rc, which branches from the inductor 241 side with respect to the branching point of the light emission branch path Rl in the resonant circuit 240, the charging switch 247 that turns the charging of the capacitor 242 ON and OFF is provided. As a result, even when the received light intensity of the reflected light with respect to the irradiated light is insufficient, it is possible to relatively enhance the light receiving sensitivity by extending and controlling the ON period Δt of the charging switch 247 prior to the ON timing td of the discharge switch 246. Consequently, by such extension control, the peak intensity of the irradiated light can be increased to a high level suitable for the reception of the reflected light, thereby ensuring the sensing accuracy of the target.

According to the first embodiment, the ON period Δt of the charging switch 247 may be controlled by adjusting the OFF timing tf of the charging switch 247, which is driven ON prior to the ON timing td of the discharge switch 246, to a time after the reference OFF timing tf0 set for the cycle. In this case, when the received light intensity of the reflected light is insufficient, the ON period Δt of the charging switch 247 can be extended by delaying the OFF timing tf of the charging switch 247 beyond the reference OFF timing tf0. As a result, by such extension control, the peak intensity of the irradiated light can be accurately increased to a high level suitable for the reception of the reflected light, thereby ensuring the sensing accuracy.

According to the first embodiment, the ON timing tn of the charging switch 247, which is driven ON prior to the ON timing td of the discharge switch 246, may be adjusted to be earlier than the reference ON timing tn0 set for the cycle, thereby enabling extension control of the ON period Δt of the charging switch 247. This adjustment is performed when the received light intensity of the reflected light is insufficient. By extending and controlling the ON period Δt of the charging switch 247 in this manner, the peak intensity of the emitted light can be precisely increased to a high level suitable for the reception of the reflected light, thereby enhancing sensing accuracy.

### Second Embodiment

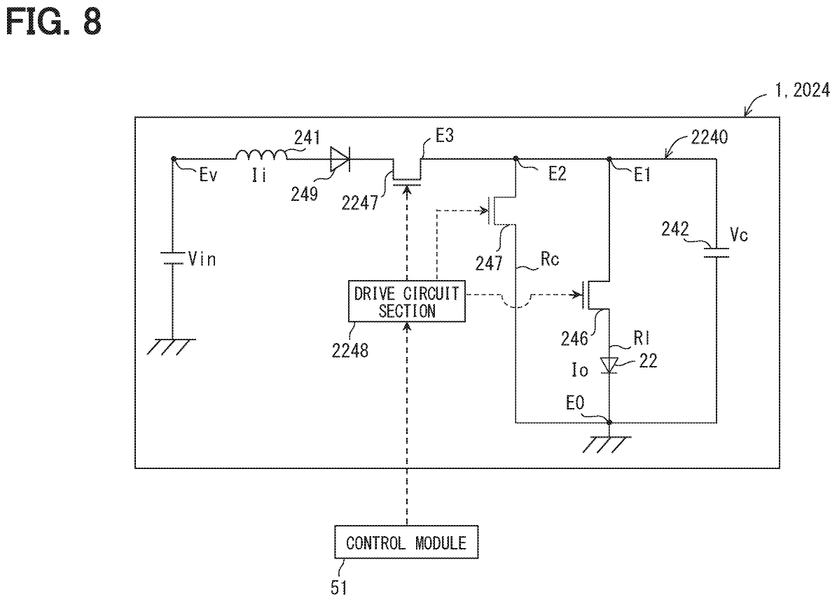

A second embodiment shown in FIG. 8 is a modification of the first embodiment.

In a light emission circuit 2024 of the second embodiment, the charging switch 247 on the control branch path Rc, as in the first embodiment, is provided as a first charging switch 247. Along with this, in the light emission circuit 2024, a second charging switch 2247 is provided between the inductor 241 and the capacitor 242 of the resonant circuit 2240.

The second charging switch 2247 is provided at a different intermediate point E3, which is located on the inductor 241 side relative to the intermediate points E1 and E2, where each branch path Rl and Rc branches between the inductor 241 and the capacitor 242 in the resonant circuit 2240. The second charge switch 2247 is mainly composed of a field effect transistor such as a MOSFET. By being arranged at this intermediate point E3, the second charging switch 2247 can turn the charging of the capacitor 242 ON and OFF by switching. Furthermore, in the resonant circuit 2240 of the second embodiment, a reverse current prevention diode 249 is provided between the inductor 241 and the intermediate point E3, thereby reducing a decrease in the charging voltage to the capacitor 242.

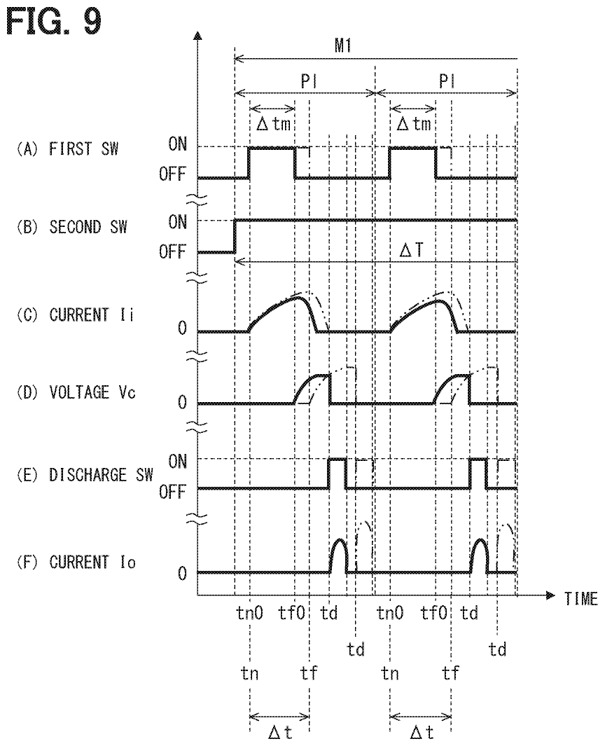

The second charging switch 2247 is driven ON and OFF independently from the other switches 246 and 247 by the drive circuit 2248, in accordance with control commands from the control module 51, as shown in FIGS. 9 to 14. That is, the drive circuit 2248 individually controls the ON/OFF operation of the discharge switch 246, the first charging switch 247, and the second charging switch 2247. The ON/OFF driving function of the drive circuit 2248 operates in response to switching commands between control mode M1 and control mode M2, based on the peak intensity of the irradiation light determined to be necessary by the control module 51 according to the received light data obtained from the output circuit 48.

When the control module 51 determines that a high-intensity condition requiring a high peak intensity of the irradiation light has been established, including an insufficient intensity condition in which the received intensity of the reflected light falls below the lower limit at the light receiving unit 45, it issues a command to the drive circuit 2248 to switch to the first control mode M1, which achieves a higher peak intensity than the second control mode M2. While the first control mode M1 is commanded, the drive circuit 2248 holds the second charging switch 2247 in the ON state, as shown by a solid and dashed line graph in sub-figures (B) of FIGS. 9 to 11. Here, the insufficient intensity condition is a condition established, for example, when the received intensity of reflected light from a distant target falls below the lower limit intensity at the light receiving unit 45. The high-intensity condition may also be established when it becomes necessary to adjust the peak intensity of the irradiation light to a range higher than that of the second control mode M2, even if the received light intensity is higher than the lower limit intensity that serves as the determination criterion for the insufficient intensity condition.

As shown by the solid and dashed line graph in sub-figures (A) of FIGS. 9 to 11, in the drive circuit 2248 of the first control mode M1, the reference ON timing tn0 for switching the first charging switch 247 from the OFF state to the ON state is set to the initial timing of each light emission cycle Pl. In addition, the reference OFF timing tf0 for switching the first charging switch 247 from the ON state to the OFF state is set, for each light emission cycle Pl, to a timing that occurs after a fixed period Δtm has elapsed from the reference ON timing tn0. With these periodic settings, the minimum ON period Δtm is defined for the first charging switch 247.

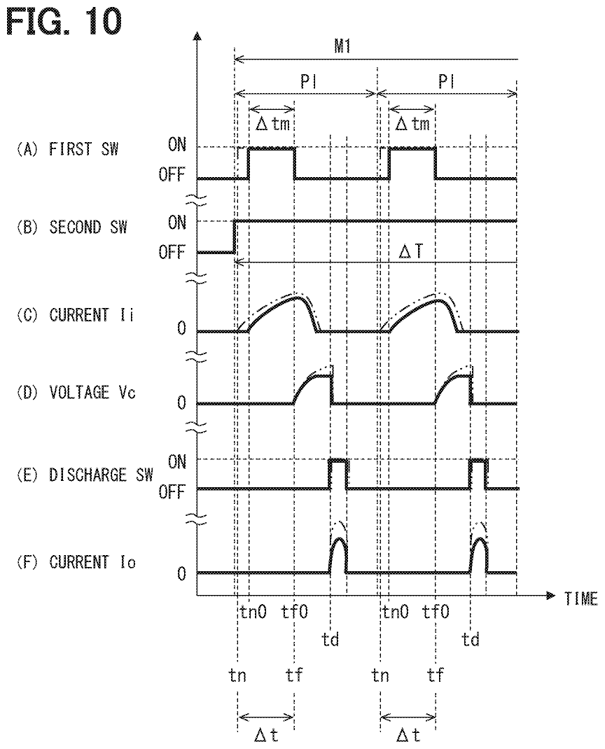

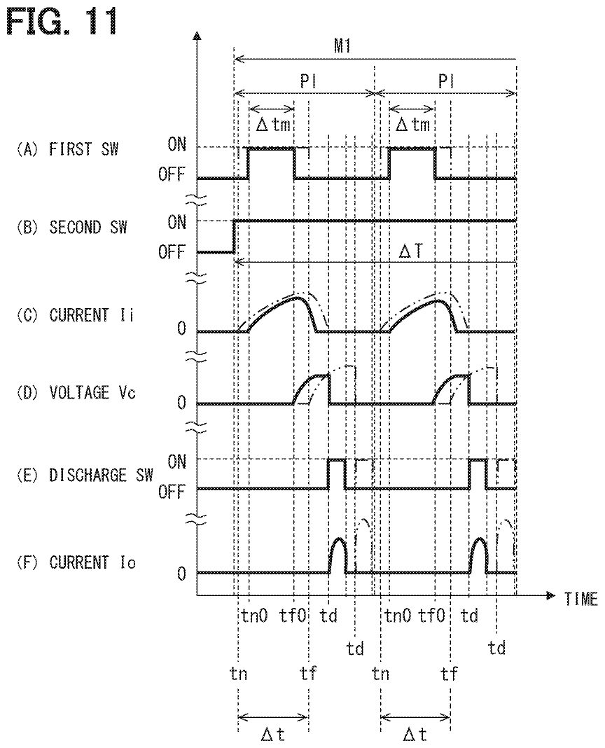

During the ON period ΔT of the second charging switch 2247, the drive circuit 2248 in the first control mode M1 controls the ON period Δt of the first charging switch 247, for each light emission cycle Pl, so that the ON period Δt is equal to or longer than the minimum ON period Δtm. At this time, the drive circuit 2248 adjusts the ON timing tn of the first charging switch 247 to match the reference ON timing tn0, and may also adjust the OFF timing tf to a variable timing after the reference OFF timing tf0 (see FIG. 9(A)). Additionally, the drive circuit 2248 adjusts the OFF timing tf of the first charging switch 247 to match the reference OFF timing tf0, and may also adjust the ON timing tn to a variable timing before the reference ON timing tn0, as long as it is after the initial timing of each light emission cycle Pl (see FIG. 10(A)). Furthermore, the drive circuit 2248 may adjust the ON timing tn of the first charging switch 247 to a variable timing before the reference ON timing tn0, as long as it is after the initial timing of each light emission cycle Pl, and may also adjust the OFF timing tf to a variable timing after the reference OFF timing tf0 (see FIG. 11(A)).

By any of the above adjustments, in the first control mode M1, the longer the drive circuit 2248 extends the ON period Δt of the first charging switch 247 beyond the minimum ON period Δtm, the greater the time and magnitude of the current Ii (see FIG. 8) flowing through the inductor 241 in the resonant circuit 2240 (see FIGS. 9 to 11, sub-figure (C)). Accordingly, the voltage Vc charged to the capacitor 242 in the resonant circuit 2240 (see FIG. 8) also increases (see FIGS. 9 to 11, sub-figure (D)). That is, the more the drive circuit 2248 extends the ON period Δt of the first charging switch 247 beyond the minimum ON period Δtm, the more the charging voltage Vc of the capacitor 242 increases, within the range defined by equation 2 as in the first embodiment.

Therefore, during the ON period ΔT of the second charging switch 2247, the drive circuit 2248 turns on the discharge switch 246, which is in the OFF drive state, at a timing later than the OFF timing tf of the first charging switch 247, for each light emission cycle Pl (see FIGS. 9 to 11, sub-figure (E)). In other words, the control of the ON period Δt for driving the first charging switch 247 ON by the drive circuit 2248 is performed prior to the ON timing td at which the discharge switch 246, which is in the OFF drive state, is switched to the ON drive state, for each light emission cycle Pl during the ON period ΔT of the second charging switch 2247.

In response to the ON driving of the discharge switch 246, in the light emitting branch path Rl, the discharge current discharged from the capacitor 242, which is in the charged voltage Vc state, flows in through the resonant circuit 2240. As a result, a current Io (see also FIG. 8) that rises and falls in accordance with the charging voltage Vc flows through the light-emitting diode 22, and the light-emitting diode 22 emits light with a peak intensity that follows the rise and fall of the current Io, as shown by the solid line graphs and dashed-dot line graphs corresponding to the each of sub-figures (F) of FIGS. 9 to 11.

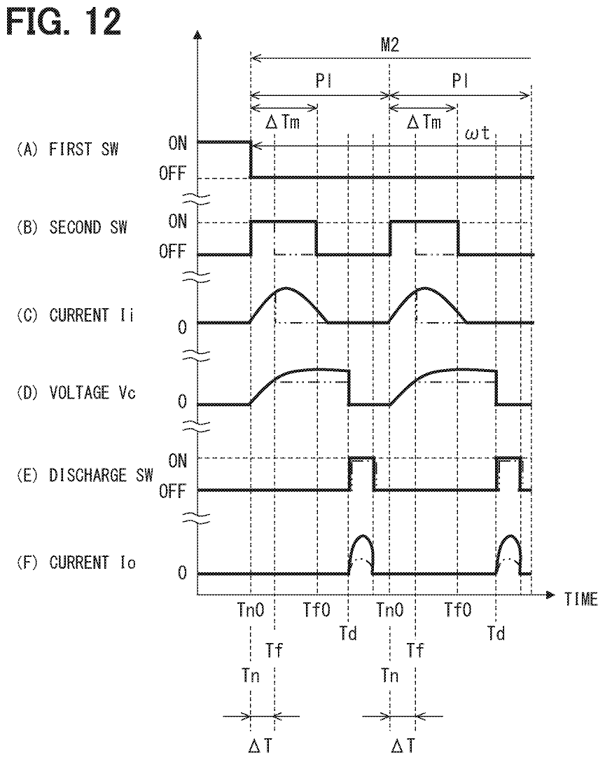

When the control module 51 determines that a low intensity condition, which requires a lower peak intensity of the irradiation light and includes an intensity saturation condition where the intensity of reflected light received by the light receiving unit 45 exceeds the upper limit intensity, has been established, it instructs the drive circuit 2248 to switch to the second control mode M2, which sets the peak intensity lower than in the first control mode M1. As a result, as shown in sub-figure (A) of FIGS. 12 to 14, the drive circuit 2248 in the second control mode M2 holds the first charging switch 247 in the OFF state while the low intensity condition is established. Here, the intensity saturation condition included in the low intensity condition is, for example, a condition established when the intensity of reflected light from a nearby target or a highly reflective target exceeds the upper limit intensity at the light receiving unit 45. The low intensity condition may also be established when it is necessary to adjust the peak intensity of the irradiation light to a level lower than in the first control mode M1, even if the received light intensity is lower than the upper limit intensity used as the determination criterion for the intensity saturation condition.

As shown by the solid and dashed line graph in sub-figures (B) of FIGS. 12 to 14, in the drive circuit 2248 of the second control mode M2, the reference ON timing Tn0 for switching the second charging switch 2247 from the OFF state to the ON state is set to the initial timing of each light emission cycle Pl. Additionally, the reference OFF timing Tf0 for switching the second charging switch 2247 from the ON drive state to the OFF drive state is set, for each light emission cycle Pl, to a timing after a fixed period ΔTm has elapsed from the reference ON timing Tn0. By setting these cycles, the maximum ON period ΔTm of the second charging switch 2247 is controlled to be substantially equal to the time constant of the resonant circuit 2240.

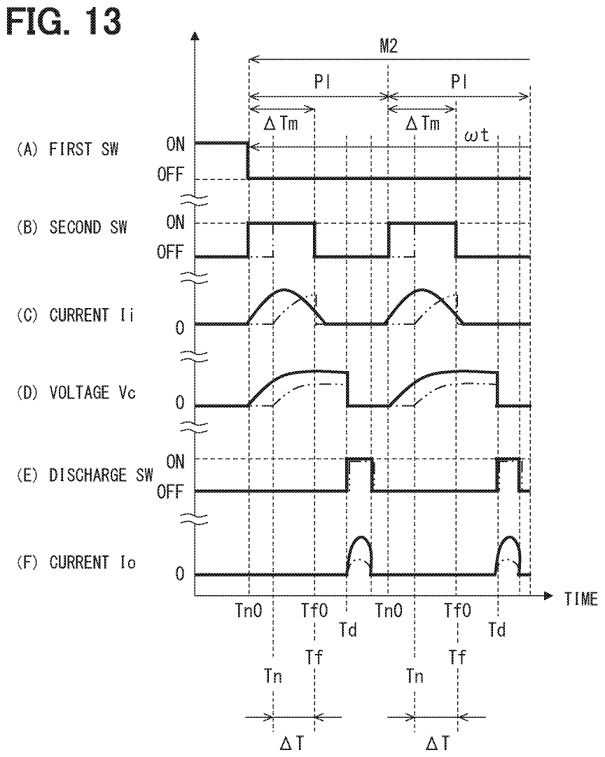

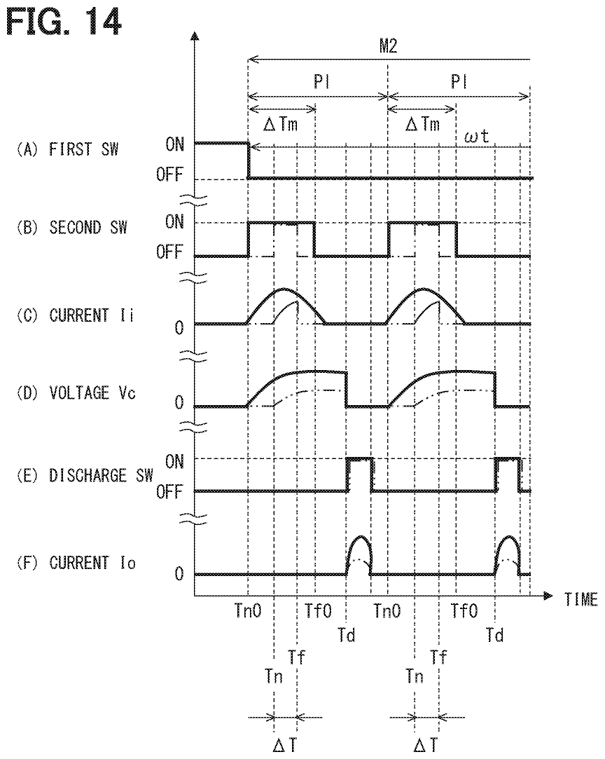

The drive circuit 2248 in the second control mode M2 controls the ON period ΔT of the second charging switch 2247, during the OFF period ωt of the first charging switch 247, to a duration not exceeding the maximum ON period ΔTm for each light emission cycle Pl. At this time, the ON timing Tn of the second charging switch 2247 is adjusted to match the reference ON timing Tn0, and the OFF timing Tf may be adjusted to a variable timing before the reference OFF timing Tf0 (see FIG. 12(B)). Additionally, the OFF timing Tf may be adjusted to match the reference OFF timing Tf0, and the ON timing Tn may be adjusted to a variable timing after the reference ON timing Tn0 (see FIG. 13(B)). Furthermore, the ON timing Tn may be adjusted to a variable timing after the reference ON timing Tn0, and the OFF timing Tf may be adjusted to a variable timing before the reference OFF timing Tf0, provided that the OFF timing Tf is later than the ON timing Tn (see FIG. 14(B)).

By any of these adjustments, in the second control mode M2, as the drive circuit 2248 shortens the ON period ΔT of the second charging switch 2247 from the maximum ON period ΔTm, the time and magnitude of the current Ii flowing through the inductor 241 in the resonant circuit 2240 decrease (see sub-figure (C) of FIGS. 12 to 14). Accordingly, the voltage Vc charged in the capacitor 242 in the resonant circuit 2240 also decreases (see sub-figure (D) of FIGS. 12 to 14). That is, as the drive circuit 2248 shortens the ON period ΔT of the second charging switch 2247 from the maximum ON period ΔTm, the charging voltage Vc of the capacitor 242 decreases within the range defined by Equation 3, where Vc in equation 1 of the first embodiment is set as the maximum charging voltage.

$$Vc < 2 * Vin \qquad ( 3 )$$

Accordingly, as shown by the solid line graphs in sub-figures (E) of FIGS. 12 to 14, in the drive circuit 2248, during the OFF period ωt of the first charging switch 247, the discharge switch 246, which is in the OFF-driven state, is turned ON at a timing later than the reference OFF-timing Tf0 of the second charging switch 2247 for each light emission cycle Pl. In other words, the control of the ON period ΔT for driving the second charging switch 2247 ON is performed prior to the ON-timing Td at which the discharge switch 246, in the OFF-driven state, is switched to the ON-driven state for each light emission cycle Pl during the OFF period ωt of the first charging switch 247.

In response to the ON driving of the discharge switch 246, in the light emitting branch path Rl, the discharge current discharged from the capacitor 242, which is in the charged voltage Vc state, flows in through the resonant circuit 2240. As a result, a current Io that rises and falls in accordance with the charging voltage Vc flows through the light-emitting diode 22, and the light-emitting diode 22 emits light with a peak intensity that follows the rise and fall of the current Io, as shown by the solid line graphs and dashed-dot line graphs corresponding to the each of sub-figures (F) of FIGS. 12 to 14.

### Actions and Effects

Effects and actions unique to the second embodiment explained above are explained below.

According to the second embodiment, in the control branch path Rc, which branches from the inductor 241 side with respect to the branching point of the light emission branch path Rl in the resonant circuit 2240, the first charging switch 247 that turns the charging of the capacitor 242 ON and OFF is provided. At the same time, in the resonant circuit 2240, the second charging switch 2247, which switches the charging of the capacitor 242 ON and OFF, is provided on the inductor 241 side with respect to the branching point of the light emission branch path Rl.

In the first control mode M1, even when the intensity of the received reflected light with respect to the irradiated light is insufficient, the control device can control the ON period Δt of the first charging switch 247, which precedes the ON-timing td of the discharge switch 246, to be extended during the ON period ΔT of the second charging switch 2247. As a result, it is possible to relatively increase the light-receiving sensitivity. Therefore, in a sensing situation where it is necessary to increase the peak intensity of the irradiated light to a high level that matches the reception of the reflected light, the above-mentioned extension control can provide a high peak intensity to the irradiated light, thereby ensuring the sensing accuracy of the target object.

On the other hand, in the second control mode M2, even when the intensity of the received reflected light with respect to the irradiated light is saturated, the control device can control the ON period ΔT of the second charging switch 2247, which precedes the ON-timing td of the discharge switch 246, to be shortened during the OFF period ωt of the first charging switch 247. As a result, it is possible to relatively lower the light-receiving sensitivity. Therefore, in a sensing situation where it is necessary to suppress the peak intensity of the irradiated light to a low level that matches the reception of the reflected light, the above-mentioned shortening control can provide a low peak intensity to the irradiated light, thereby ensuring the sensing accuracy of the target object. Furthermore, by using both the second control mode M2 and the first control mode M1, it is also possible to increase the dynamic range of light reception.

As in the second embodiment, according to the first control mode M1 in which the second charging switch 2247 is held in the ON state through hold control, the peak intensity of the emitted light can be accurately matched to the reception of the reflected light by controlling the ON period Δt of the first charging switch 247. Therefore, it becomes possible to enhance sensing accuracy.

According to the second embodiment, when a high-intensity condition is established in which the peak intensity of the emitted light needs to be higher than that in the second control mode M2, the second control mode M2 is switched to the first control mode M1. Accordingly, in sensing situations where the reception of reflected light requires a higher peak intensity of emitted light than in the second control mode M2, switching to the first control mode M1 allows timely response and ensures sensing accuracy.

In the second control mode M2 of the second embodiment, the control device can adjust the OFF timing Tf of the second charging switch 2247, which is turned ON prior to the ON timing Td of the discharge switch 246, to an earlier time than the reference OFF timing Tf0 that is set periodically. As a result, it is possible to control the ON period ΔT of the second charging switch 2247. In this case, when the received intensity of the reflected light is saturated, the control device can stably shorten and control the ON period ΔT of the second charging switch 2247 by advancing the OFF timing Tf of the second charging switch 2247 to an earlier time than the reference OFF timing Tf0. Therefore, by such shortening control, it is possible to accurately stabilize the peak intensity of the irradiated light at a low intensity that matches the received reflected light, thereby ensuring sensing accuracy.

In the second control mode M2 of the second embodiment, the control device can adjust the ON timing Tn of the second charging switch 2247, which is turned ON prior to the ON timing Td of the discharge switch 246, to a later time than the reference ON timing Tn0 that is set periodically. As a result, it is possible to control the ON period ΔT of the second charging switch 2247. In this case, when the received intensity of the reflected light is saturated, the control device can shorten and control the ON period ΔT of the second charging switch 2247 by delaying the ON timing Tn of the second charging switch 2247 to a later time than the reference ON timing Tn0. Therefore, by such shortening control, it is possible to accurately suppress the peak intensity of the irradiated light to a low intensity that matches the received reflected light, thereby improving sensing accuracy.

### Other Embodiments

Although multiple embodiments have been described above, the present disclosure is not to be construed as being restricted to these embodiments, and can be applied to various embodiments and combinations without departing from the spirit of the present disclosure.

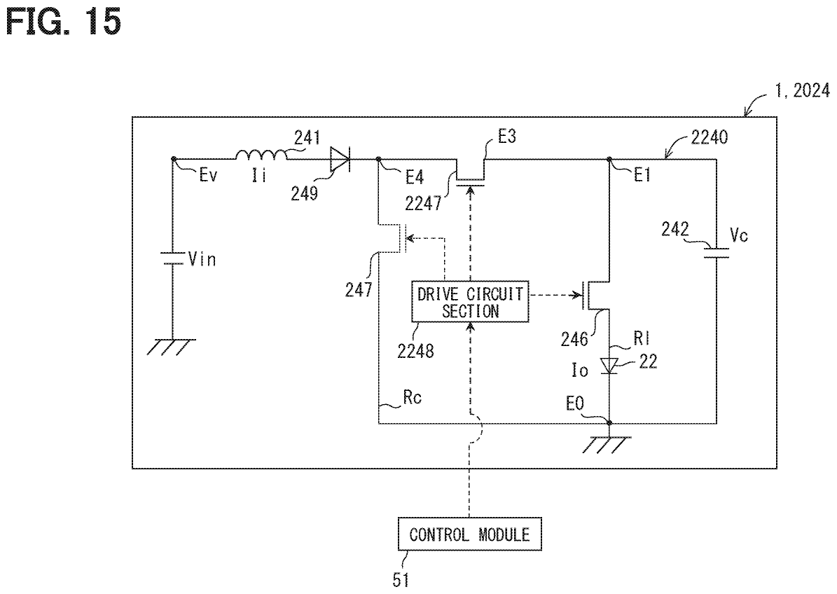

As shown in FIG. 15, in a modification of the second embodiment, the control branch path portion Rc where the first charging switch 247 is provided may branch from the intermediate point E4, which is located between the inductor 241 and the second charging switch 2247 at intermediate point E3 in the resonant circuit 2240. In the resonant circuit 2240 of this modification, by providing a diode 249 for backflow prevention between the inductor 241 and the intermediate point E4, a decrease in the charging voltage Vc to the capacitor 242 is reduced.

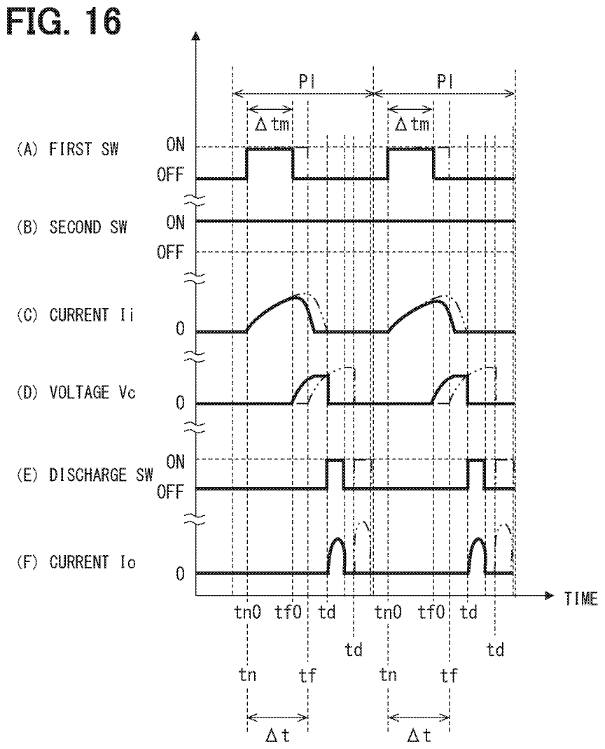

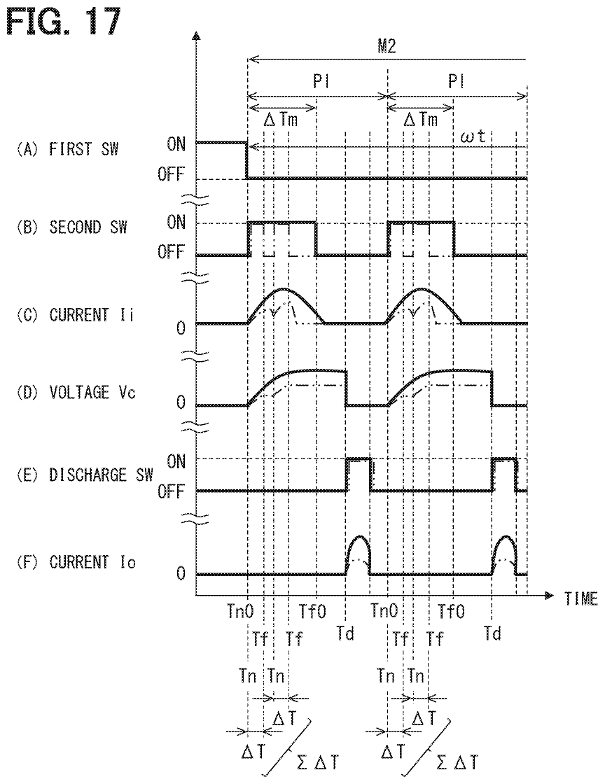

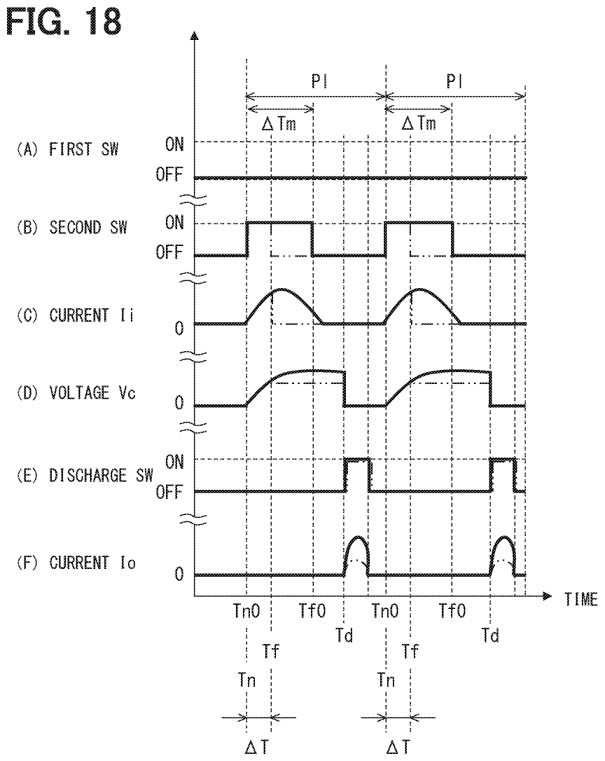

As shown in FIG. 16, in a modification of the second embodiment, the second charging switch 2247 may be held in the ON state at all times while the vehicle 5 and/or the optical sensor 2 is activated, so that, in effect, only the first control mode M1 is implemented and equivalence with the first embodiment is achieved. As shown in FIG. 17, in a modification of the second embodiment, during the second control mode M2, the ON/OFF operation of the second charging switch 2247 may be repeated within the maximum ON period ΔTm, so that the total time ΣΔT of the intermittent ON periods ΔT of the second charging switch 2247 is controlled to be shorter than the maximum ON period ΔTm. As shown in FIG. 18, in a modification of the second embodiment, and although not illustrated, in a further modification of FIG. 17, the first charging switch 247 may be held in the OFF state at all times while the vehicle 5 and/or the optical sensor 2 is activated, so that, in effect, only the second control mode M2 is implemented.

In modifications of the first and second embodiments, the vehicle 5 to which the optical sensor 2 including the light-emitting unit 1 is applied may, for example, be an autonomous driving robot capable of tasks such as cargo transportation or information collection by means of autonomous or remote driving. In modifications of the first and second embodiments, the object to which the optical sensor 2 including the light-emitting unit 1 is applied may be, for example, a moving body other than the vehicle 5, or a stationary object such as a structure.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A light emitting unit provided in an optical sensor configured to sense a target by receiving reflected light from the target in response to irradiation light emitted toward a sensing area, and configured to emit the irradiation light, the light emitting unit comprising:
a resonant circuit including an inductor and a capacitor;
a light emission branch path branching from a branching point between the inductor and the capacitor in the resonant circuit;
a light emitting diode provided in the light emission branch path and configured to generate the irradiation light by light emission;
a discharge switch provided in the light emission branch path and configured to switch discharge from the capacitor;
a control branch path branching from the inductor side relative to the branching point of the light emission branch path in the resonant circuit;
a first charge switch provided in the control branch path and configured to switch on and off charging to the capacitor;
a second charge switch provided in the resonant circuit on the inductor side relative to the branching point of the light emission branch path, and configured to switch on and off charging to the capacitor; and
a drive circuit configured to individually control on/off operation of the discharge switch, the first charge switch, and the second charge switch, wherein the drive circuit is configured to switch between a first control mode and a second control mode,
the first control mode is a mode, in which, prior to an on-timing of the discharge switch, an on-period of the first charge switch is controlled during an on-period of the second charge switch, and
the second control mode is a mode, in which, prior to an on-timing of the discharge switch, an on-period of the second charge switch is controlled during an off-period of the first charge switch.

2. The light emitting unit according to claim 1, wherein
the drive circuit is configured to control, in the first control mode, the on-period of the first charge switch by adjusting an off-timing of the first charge switch, which is turned on prior to the on-timing of the discharge switch, to a timing after a periodically set reference off-timing.

3. The light emitting unit according to claim 1, wherein
the drive circuit is configured to control, in the first control mode, the on-period of the first charge switch by adjusting an on-timing of the first charge switch, which is turned on prior to the on-timing of the discharge switch, to a timing before a periodically set reference off-timing.

4. The light emitting unit according to claim 1, wherein
the drive circuit is configured to maintain, in the first control mode, the second charge switch in an on state.

5. The light emitting unit according to claim 1, wherein
the drive circuit is configured to switch from the second control mode to the first control mode in response to determining that a high intensity condition, in which a peak intensity of the irradiation light is higher than the peak intensity in the second control mode, is satisfied.

6. The light emitting unit according to claim 1, wherein
the drive circuit is configured to control, in the second control mode, the on-period of the second charge switch by adjusting an off-timing of the second charge switch, which is turned on prior to the on-timing of the discharge switch, to a timing before a periodically set reference off-timing.

7. The light emitting unit according to claim 1, wherein
the drive circuit is configured to control, in the second control mode, the on-period of the second charge switch by adjusting an on-timing of the second charge switch, which is turned on prior to the on-timing of the discharge switch, to a timing before a periodically set reference off-timing.

8. An optical sensor comprising:
the light emitting unit according to claim 1; and
a light receiving unit configured to receive the reflected light in response to the irradiation light emitted from the light emitting unit.
